(19) United States
(12) Patent Application Publication
(10) Pub. No.: US 2014/0147740 A1
(43) Pub. Date: May 29, 2014

(54) POSITIVE ELECTRODE ACTIVE MATERIAL FOR NONAQUEOUS ELECTROLYTE SECONDARY BATTERY AND METHOD FOR PRODUCING THE SAME, POSITIVE ELECTRODE FOR NONAQUEOUS ELECTROLYTE SECONDARY BATTERY USING POSITIVE ELECTRODE ACTIVE MATERIAL, AND NONAQUEOUS ELECTROLYTE SECONDARY BATTERY USING POSITIVE ELECTRODE

(71) Applicants: Takao Kokubu, Hyogo (JP); Hiroyuki Matsumoto, Frisco, TX (US); Takeshi Ogasawara, Hyogo (JP)

(72) Inventors: Takao Kokubu, Hyogo (JP); Hiroyuki Matsumoto, Frisco, TX (US); Takeshi Ogasawara, Hyogo (JP)

(73) Assignee: SANYO ELECTRIC CO., LTD., Moriguchi-shi, Osaka (JP)

(21) Appl. No.: 14/233,339

(22) PCT Filed: Jul. 27, 2012
(86) PCT No.: PCT/JP2012/069134

§ 371 Date: Jan. 16, 2014

(30) Foreign Application Priority Data
Jul. 29, 2011 (JP) 2011-166909

(51) Int. Cl. H01M 4/36; B05D 1/02

(52) U.S. Cl. CPC H01M 4/366; B05D 1/02
USPC 429/188; 429/211; 429/231.1; 427/77

(57) ABSTRACT

Provided is a positive electrode active material for a nonaqueous electrolyte secondary battery in which generation of gas resulting from a reaction between a lithium transition metal complex oxide and an electrolyte is suppressed even when the battery is stored at high temperature, thereby improving the reliability of the battery, suppressing deterioration of the lithium transition metal complex oxide, and suppressing the decrease in battery capacity. In the positive electrode active material, a compound containing zirconium and fluorine is attached to a surface of lithium cobaltate. This positive electrode active material can be produced by spraying a solution containing zirconium and fluorine onto lithium cobaltate while stirring lithium cobaltate.

### TECHNICAL FIELD

The present invention relates to a positive electrode active material for a nonaqueous electrolyte secondary battery and the like.

### BACKGROUND ART

In recent years, size and weight reduction of portable information terminals such as cellular phones, laptop personal computers, and smart phones has seen rapid progress and batteries used as the drive power sources therefor have also been required to have higher capacity. Nonaqueous electrolyte secondary batteries that are charged and discharged through migration of lithium ions between positive and negative electrodes offer high energy density and high capacity and thus are widely used as the drive power sources of portable information terminals such as those listed above.

Portable information terminals are showing an increasing tendency to consume more power as they perform enhanced functions such as a moving-image playing function and a gaming function and thus the batteries are required to offer higher capacity and improved cycle characteristics.

The following proposals have been made from such viewpoints:

(1) A proposal of improving cycle characteristics by coating surfaces of a positive electrode active material with AlF₂, ZnF₂, or LiF so as to diminish the influence of acids generated near the positive electrode active material and to suppress reactivity of the positive electrode active material with the electrolyte (see PTL 1 below)
(2) A proposal of improving cycle characteristics and suppressing generation of heat under DSC measurement by firing a mixture of zirconium oxide and LCO so as to allow zirconium oxide to attach to surfaces of a positive electrode active material (see PTL 2 below) Citation List

### Patent Literature

PTL 1: Japanese Published Unexamined Patent Application No. 2008-536285
PTL 2: Japanese Published Unexamined Patent Application No. 2003-221234

### SUMMARY OF INVENTION

### Technical Problem

As the trends of the portable information terminals described above shift, laminate-type batteries and prismatic batteries have increasingly come to use compared to cylindrical batteries. Laminate-type batteries and prismatic batteries have softer outer casings than cylindrical batteries. Accordingly, when gas is generated as a result of reaction between a positive electrode active material and an electrolyte and the pressure inside the battery is elevated, the outer casings deform readily. As a result, battery swelling occurs which leads to breaking of parts of equipment in which the battery is used, for example. In particular, in small devices such as smart phones, the space in which the battery is placed is significantly limited and thus the aforementioned problem occurs frequently. Thus there is a need to suppress generation of gas inside the battery and swelling of the battery irrespective of the conditions under which the battery is used. However, the proposals (1) and (2) described above cannot resolve this problem since large quantities of gas is generated by storing the battery at high temperature. Moreover, since the positive electrode active material becomes deteriorated by generation of gas, there is another problem of a decrease in battery capacity.

### Solution to Problem

To address the problems described above, a positive electrode active material for a nonaqueous electrolyte secondary battery according to the present invention includes a lithium transition metal complex oxide and a compound containing zirconium and fluorine atoms. The compound is present at a surface of the lithium transition metal complex oxide.

### Advantageous Effects of Invention

The present invention offers an excellent effect of suppressing generation of gas and a decrease in discharge capacity even when a battery in a charged state is exposed to a high-temperature environment.

### BRIEF DESCRIPTION OF DRAWINGS

FIG. 1 is a front view of a nonaqueous electrolyte secondary battery according to an embodiment of the present invention.

FIG. 2 is a cross-sectional view taken along line A-A in FIG. 1.

### DESCRIPTION OF EMBODIMENTS

A positive electrode active material for a nonaqueous electrolyte secondary battery and the like according to the present invention will now be described. Note that the positive electrode active material for an nonaqueous electrolyte secondary battery and the like according to the present invention are not limited to the embodiments described above and various alterations and modifications are possible without departing from the essence of the invention.

### [Production of Positive Electrode]

(Preparation of Coating Solution to be Sprayed onto Surfaces of Lithium Cobaltate)

A mixture of 4.8 g of zirconium ammonium carbonate (a 13% solution on a ZrO₂ basis) and 0.76 g of ammonium fluoride was diluted to 75 ml with distilled water to prepare a coating solution.

### (Coating of Lithium Cobaltate)

While 500 g of lithium cobaltate in which 0.1 mol % of Al and 0.1 mol % of Mg were dissolved was being stirred on a fluorine-coated tray with a polypropylene spatula, the coating solution was sprayed onto the lithium cobaltate by using a sprayer. The lithium cobaltate sprayed with the coating solution was dried for 2 hours at 120° C. As a result, a positive electrode active material in which a compound containing zirconium and fluorine was attached to surfaces of lithium cobaltate was obtained.

### (Preparation of Positive Electrode Slurry)

First, the positive electrode active material was mixed with a carbon black (acetylene black with an average particle size of 40 nm) powder serving as a positive electrode conductive agent and a solution containing dispersed polyvinylidene fluoride (PVdF) as a positive electrode binder so as to prepare a positive electrode mix slurry. The ratio of the positive electrode active material to the positive electrode conductive agent to the positive electrode binder was adjusted to 95:2.5:2.5 in terms of amount by mass. Next, the positive electrode mix slurry was applied to both surfaces of a positive electrode current collector constituted by an aluminum foil, dried at 120° C., and rolled with a rolling roller. As a result, a positive electrode in which positive electrode mix layers were respectively formed on the two surfaces of the positive electrode current collector was obtained. The content of the compound containing zirconium and fluorine was 0.0934 mass % relative to lithium cobaltate on a zirconium element basis.

### [Production of Negative Electrode]

Artificial graphite serving as a negative electrode active material, sodium carboxymethyl cellulose (CMC) serving as a dispersant, and styrene-butadiene rubber (SBR) serving as a binder were mixed in an aqueous solution at a mass ratio of 98:1:1 so as to prepare a negative electrode mix slurry. Next, the negative electrode mix slurry was uniformly applied to both surfaces of a negative electrode current collector constituted by a copper foil, dried, and rolled with a rolling roller. As a result, a negative electrode in which negative electrode mix layers were respectively formed on the two surfaces of the negative electrode current collector was obtained. The packing density of the negative electrode active material in the negative electrode was 1.70 g/cm³.

### [Preparation of Nonaqueous Electrolyte]

Lithium hexafluorophosphate (LiPF₆) was dissolved in a mixed solvent prepared by mixing ethylene carbonate (EC) and dimethyl carbonate (DEC) at a volume ratio of 3:7 so that the concentration thereof was 1.0 mol/L so as to prepare a nonaqueous electrolyte.

### [Production of Battery]

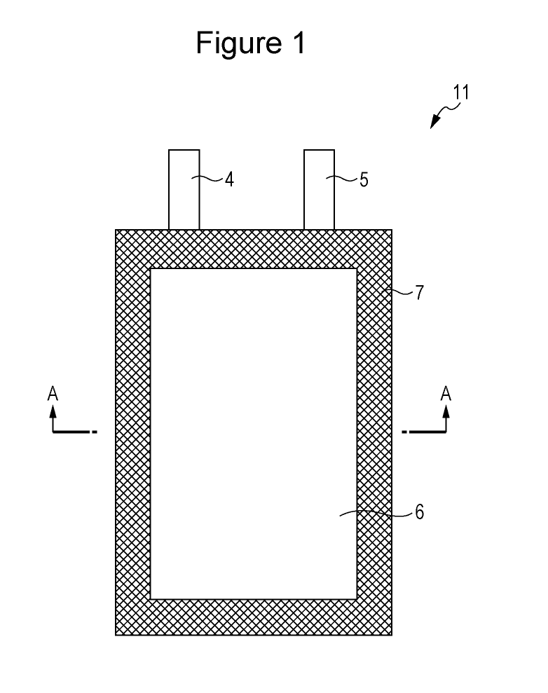

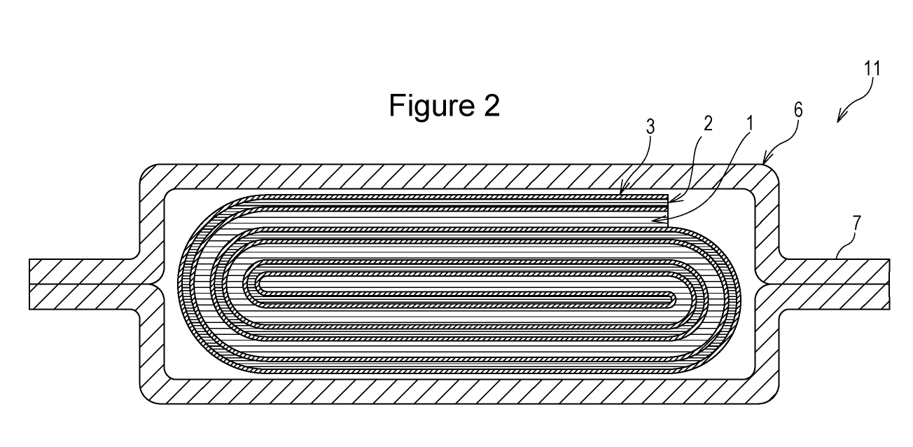

Current collecting tabs were attached to the positive and negative electrodes, a separator was placed between the two electrodes, and the resulting stack was spirally wound. A winding core was removed to obtain a spiral electrode assembly. The spiral electrode assembly was flattened to obtain a flat electrode assembly. Then the flat electrode assembly and the nonaqueous electrode were inserted into an outer casing composed of an aluminum laminate so as to prepare a nonaqueous electrode secondary battery having a structure shown in FIGS. 1 and 2. The nonaqueous electrolyte secondary battery was 3.6 mm×35 mm×62 mm in size. The discharge capacity observed when the nonaqueous electrolyte secondary battery was charged to 4.40 V and discharged to 2.75 V was 750 mAh.

Referring now to FIGS. 1 and 2, a specific structure of the nonaqueous electrolyte secondary battery 11 is described. A positive electrode 1 and a negative electrode 2 are arranged to oppose each other with a separator 3 therebetween and a flat electrode assembly constituted by the positive and negative electrodes 1 and 2 and the separator 3 is impregnated with a nonaqueous electrolyte. The positive electrode 1 and the negative electrode 2 are respectively connected to a positive electrode current collecting tab 4 and a negative electrode current collecting tab 5 so that this structure can function as a secondary battery capable of charging and discharging. The electrode assembly is disposed in a housing space of an aluminum laminate outer casing 6 having a closing portion 7 where peripheries are heat-sealed to each other.

### EXAMPLES

### First Example

### Example 1

A battery was produced as in the embodiment of the present invention described above.

The battery produced thereby is hereinafter referred to as battery A1.

### Example 2

A battery was produced as in Example 1 except that 1.05 g of citric acid monohydrate was mixed in preparing the coating solution.

The battery produced thereby is hereinafter referred to as battery A2.

### Comparative Example 1

A battery was produced as in Example 1 except that a positive electrode active material not sprayed with the coating solution (positive electrode active material solely composed of lithium cobaltate) was used.

The battery produced thereby is hereinafter referred to as battery R1.

### Comparative Example 2

A battery was produced as in Example 1 except that ammonium fluoride was not added in preparing the coating solution.

The battery produced thereby is hereinafter referred to as battery R2.

### Comparative Example 3

A battery was produced as in Example 1 except that an aqueous solution containing 0.13 g of lithium fluoride was used as the coating solution in preparing the coating solution.

The battery produced thereby is hereinafter referred to as battery R3.

### Experiment

The batteries A1, A2, and R1 to R3 were subjected to charging/discharging, etc., by the methods described below to examine high-temperature continuous charge properties (proportion of battery swelling caused by generation of gas and remaining capacity rate). The results are shown in Table 1.

Charging and Discharging Conditions Before a Continuous Charge Test

Constant-current charging was performed with a current of 1.0 It (750 mA) until the battery voltage reached 4.40 V and then constant-voltage charging was performed at 4.40 V until the current reached It/20 (37.5 mA). After 10 minutes of pause, constant-current discharging was performed at a current of 1.0 It (750 mA) until the battery voltage reached 2.75 V. The discharge capacity was measured during this discharge and assumed to be a discharge capacity before the continuous charge test.

Charge and Discharge Conditions During Continuous Charge Test

Charging and discharging were performed once under the above-described charge and discharge conditions and then the battery was left in a constant-temperature oven at 60° C. for one hour. Next, in a 60° C. environment, constant-current charging was performed at a constant current of 1.0 It (750 mA) until the battery voltage reached 4.40 V and then constant-voltage charging was performed at 4.40 V. The total charging time in the 60° C. environment was 60 hours.

Measurement after Continuous Charge Test

The thickness of each battery taken out from the 60° C. constant-temperature oven was measured and assumed to be the battery thickness after the continuous charge test. The proportion of battery swelling caused by generation of gas was calculated from the equation (1) below using the observed value and the battery thickness at the time the battery was produced (3.6 mm):

Proportion of battery swelling(%)=([battery thickness after the continuous charge test−battery thickness at the time the battery was produced]/battery thickness at the time the battery was produced)×100 (1)

After the thickness of the battery was measured, the battery was cooled to room temperature. Then charging and discharging were performed at room temperature under the same conditions as the charge and discharge conditions before the continuous charge test so as to measure the discharge capacity of the first cycle after the continuous charge test. Then the remaining capacity rate expressed by formula (2) below was calculated:

Remaining capacity rate(%)=(discharge capacity of the first cycle after the continuous charge test/charge capacity before the continuous charge test)×100 (2)

TABLE 1

| | Positive electrode | | | | |
|---|---|---|---|---|---|
| | active material | | | | |
| | Lithium | | | Proportion | Re- |
| | transition | Compound | | of battery | maining |
| | metal com- | attached to | Electro- | swelling | capacity |
| Battery | plex oxide | surface | lyte | (%) | rate (%) |
| Battery A1 | Lithium | Zr—F | EC/ | 21.4 | 83.5 |
| Battery A2 | cobaltate | Zr—F | DEC | 31.7 | 84.5 |
| | | (with citric | | | |
| | | acid) | | | |
| Battery R1 | | None | | 89.7 | 75.1 |
| Battery R2 | | Zr—O | | 56.4 | 79.6 |
| Battery R3 | | Li—F | | 85.3 | 80.2 |

Table 1 shows that generation of gas caused by decomposition of the electrolyte is significantly suppressed and thus battery swelling is significantly suppressed in the batteries A1 and A2 in which a compound containing zirconium and fluorine is the compound attached to the surfaces of lithium cobaltate even after the batteries are retained at high temperature and a high voltage compared to the battery R1 in which no compound is attached to the surfaces of lithium cobaltate, the battery R2 in which zirconium oxide is the compound attached to surfaces of lithium cobaltate, and the battery R3 in which a compound containing lithium and fluorine is the compound attached to surfaces of lithium cobaltate. Suppressing the reaction between the electrolyte and lithium cobaltate leads to suppression of deterioration of lithium cobaltate. Accordingly, the batteries A1 and A2 have higher remaining capacity rates than the batteries R1 to R3.

The reason is probably that presence of a compound containing zirconium and fluorine at the surfaces of lithium cobaltate can prevent lithium cobaltate from contacting the electrolyte. In addition, since the compound contains fluorine, the activation energy for the electrolyte decomposition reaction can be increased and thus the decomposition reaction of the electrolyte caused by the catalytic action of the transition metal in the lithium transition metal complex oxide can be suppressed. Note that in the case of the battery R3, decomposition of the electrolyte cannot be suppressed due to the following reason. That is, LiPF₆ or the like used as a supporting salt in the battery is known to generate PF₅ upon reacting with water which is contained in minute amounts in some cases. Since PF₅ acts as a Lewis acid, LiF contained in the battery R3 reacts with PF₅ and partly dissolves in the electrolyte. In addition, the compound LiF itself cannot exhibit an effect of increasing the activation energy for the electrolyte decomposition reaction, and thus, suppression of battery swelling and improvements of the remaining capacity rate could not be achieved in the battery R3.

Note that compared to the battery A1 in which no citric acid is added, the battery A2 in which citric acid serving as a chelating agent is added exhibits a high remaining capacity rate but the battery swelling caused by generation of gas is larger. Accordingly, in order to improve the remaining capacity rate, it is preferable to add a chelating agent and in order to suppress battery swelling caused by generation of gas, it is preferable not to add a chelating agent.

### Second Example

### Example

A battery was produced as in Example 1 of the first example except that a mixed solvent containing fluoroethylene carbonate (FEC) and methyl ethyl carbonate (MEC) at a volume ratio of 2:8 was used as the solvent for the nonaqueous electrolyte.

The battery produced thereby is hereinafter referred to as battery B.

### Comparative Example 1

A battery was produced as in Example of the second example except that a positive electrode active material not sprayed with the coating solution (positive electrode active material solely composed of lithium cobaltate) was used.

The battery produced thereby is hereinafter referred to as battery S1.

### Comparative Example 2

A battery was produced as in Example of the second example except that ammonium fluoride was not added in preparing the coating solution.

The battery produced thereby is hereinafter referred to as battery S2.

### Experiment

The batteries B, S1, and S2 were subjected to charging/discharging, etc., under the same conditions as those of the experiment described in the first example to examine high-temperature continuous charge properties (amount of battery swelling caused by generation of gas (hereinafter may be simply referred to as battery swelling amount) and remaining capacity rate). The results are shown in Table 2.

The battery swelling amount is the quantity expressed by equation (3) below. In Table 2, the battery swelling amount is indicated as an index number relative to the battery swelling amount of the battery S1 which is assumed to be 100.

Battery swelling amount=battery thickness after continuous charge test−battery thickness at the time the battery was produced (3)

The remaining capacity rate is the ratio shown by equation (2) in the experiment of the first example. In Table 2, the remaining capacity rate is indicated as an index number relative to the remaining capacity rate of the battery S1 which is assumed to be 100.

TABLE 2

| | Positive electrode | | | | |
|---|---|---|---|---|---|
| | active material | | | | |
| | Lithium | | | | |
| | transition | Compound | | Battery | Remaining |
| | metal com- | attached to | Electro- | swelling | capacity |
| Battery | plex oxide | surface | lyte | amount | rate |
| Battery B | Lithium | Zr—F | FEC/MEC | 36.4 | 119.0 |
| Battery S1 | cobaltate | None | | 100 | 100 |
| Battery S2 | | Zr—O | | 46.2 | 111.4 |

Table 2 shows that, battery swelling is significantly suppressed in the battery B in which a compound containing zirconium and fluorine is the compound attached to surfaces of lithium cobaltate even after the battery is retained at high temperature and high voltage, compared with the battery S1 in which no compound is attached to surfaces of lithium cobaltate and the battery S2 in which zirconium oxide is the compound attached to surfaces of lithium cobaltate. The battery B also exhibits a higher remaining capacity rate than the batteries S1 and S2. The reason for this is presumably the same as that described in the experiment of the first example. The experimental results described above show that the effects of the present invention can be achieved even when the type of the electrolyte is changed.

### Third Example

### Example

A battery was produced as in Examples of the second example except that 1 mass % of adiponitrile was added in preparing the nonaqueous electrolyte.

The battery produced thereby is hereinafter referred to as battery C.

### Comparative Example 1

A battery was produced as in Comparative Example 1 of the second example except that 1 mass % of adiponitrile was added in preparing the nonaqueous electrolyte.

The battery produced thereby is hereinafter referred to as battery T1.

### Comparative Example 2

A battery was produced as in Comparative Example 2 of the second example except that 1 mass % of adiponitrile was added in preparing the nonaqueous electrolyte.

The battery produced thereby is hereinafter referred to as battery T2.

### Experiment

The batteries C, T1, and T2 were subjected to charging/discharging, etc., under the same conditions as those of the experiment described in the first example to examine high-temperature continuous charge properties (battery swelling amount and remaining capacity rate). The results are shown in Table 3. Note that in Table 3, the battery swelling amount is indicated as an index number relative to the battery swelling amount of the battery T1 which is assumed to be 100 and the remaining capacity rate is indicated as an index number relative to the remaining capacity rate of the battery T1 which is assumed to be 100.

The battery swelling reduction rate was calculated from equation (4) below in order to determine the swelling reduction rate achieved by addition of adiponitrile to the electrolyte. The results are shown in Table 4. In equation (4), in the case where the battery C was used as an adiponitrile-containing battery, the battery B not containing adiponitrile was used as the reference of the comparison. In the case where the battery T1 was used as an adiponitrile-containing battery, the battery S1 not containing adiponitrile was used as the reference of the comparison. In the case where the battery T2 was used as an adiponitrile-containing battery, the battery S2 not containing adiponitrile was used as the reference of the comparison.

Swelling reduction rate achieved by addition of adiponitrile (%)=(1−[thickness of adiponitrile-containing battery after continuous charge test−thickness of adiponitrile-containing battery at the time the battery was produced]/[thickness of battery not containing adiponitrile after continuous charge test−thickness of battery not containing adiponitrile at the time the battery was produced])×100 (4)

TABLE 3

| | Positive electrode | | | | |
|---|---|---|---|---|---|
| | active material | | | | |
| | Lithium | | | | |
| | transition | Compound | | Battery | Remaining |
| | metal com- | attached to | Electro- | swelling | capacity |
| Battery | plex oxide | surface | lyte | amount | rate |
| Battery C | Lithium | Zr—F | FEC/MEC | 35.4 | 115.5 |
| Battery T1 | cobaltate | None | With | 100 | 100 |
| Battery T2 | | Zr—O | nitrile | 59.0 | 112.7 |

Table 3 shows that, battery swelling is significantly suppressed in the battery C in which a compound containing zirconium and fluorine is the compound attached to the surfaces of lithium cobaltate even after the battery was held at high temperature and high voltage compared with the battery T1 in which no compound is attached to surfaces of lithium cobaltate and the battery T2 in which zirconium oxide is the compound attached to surfaces of lithium cobaltate. Moreover, the battery C exhibits a higher remaining capacity rate than the batteries T1 and T2. The reason for this is presumably the same as that described in the experiment of the first example. The experimental results described above show that the effects of the present invention can be achieved even when the type of electrolyte (also refers to the type of additives) is changed.

TABLE 4

| | Positive electrode | | |
|---|---|---|---|
| | active material | | Swelling reduction |
| | Lithium | Compound | rate achieved by |
| | transition metal | attached to | addition of |
| Battery | complex oxide | surface | adiponitrile (%) |
| Battery C/ | Lithium | Zr—F | 67.3 |
| Battery B | cobaltate | | |
| Battery T1/ | | None | 56.3 |
| Battery S1 | | | |
| Battery T2/ | | Zr—O | 63.0 |
| Battery S2 | | | |

Table 4 shows that battery swelling is significantly suppressed in the batteries C, T1, and T2 in which adiponitrile serving as a compound having a nitrile group is added to the electrolyte compared to the batteries B, S1, and S2 in which no adiponitrile is added. In particular, the battery C in which a compound containing fluorine and zirconium is attached to surfaces of lithium cobaltate exhibits the highest swelling reduction rate. It is considered that since the nitrile compound forms a coating film in which nitrile groups are coordinated to the surfaces of the positive electrode active material, an effect of suppressing decomposition of the electrolyte and generation of gas is realized. However, in the case where zirconium oxide is attached to surfaces of lithium cobaltate, some nitrile groups are coordinated to zirconium oxide and the effect is not sufficiently exhibited. In contrast, when a compound containing fluorine and zirconium is attached to surfaces of lithium cobaltate, the nitrile groups are selectively coordinated to the surfaces of transition metal and thus a sufficient effect is exhibited. Accordingly, in the case where a compound having nitrile groups such as adiponitrile is added to the electrolyte, it is most preferable to have a compound containing fluorine and zirconium attached to surfaces of lithium cobaltate.

### Fourth Example

### Example

A battery was produced as in Example 1 of the first example except that LiNi_{0.33}CO_{0.33}Mn_{0.33}O₂ (hereinafter may be referred to as NCM) was used as the lithium transition metal complex oxide.

The battery produced thereby is hereinafter referred to as battery D.

### Comparative Example

A battery was produced as in Example of the fourth example except that a positive electrode active material not sprayed with a coating solution (positive electrode active material solely composed of NCM) was used.

The battery produced thereby is hereinafter referred to as battery U.

### Experiment

The batteries D and U were subjected to charging/discharging, etc., under the same conditions as those of the experiment of the first example described above to examine the high-temperature continuous charge properties (proportion of battery swelling and remaining capacity rate). The results are shown in Table 5.

TABLE 5

| | Positive electrode | | | | |
|---|---|---|---|---|---|
| | active material | | | | |
| | Lithium | | | Proportion | Re- |
| | transition | Compound | | of battery | maining |
| | metal com- | attached to | Electro- | swelling | capacity |
| Battery | plex oxide | surface | lyte | (%) | rate (%) |
| Battery D | NCM | Zr—F | EC/DEC | 7.2 | 78.0 |
| Battery U | | None | | 14.5 | 67.5 |

Table 5 shows that, compared to the battery U in which no compound is attached to the surfaces of NCM, the battery swelling is significantly suppressed in the battery D in which a compound containing zirconium and fluorine is the compound attached to the surfaces of NCM even after the battery is retained at high temperature and high voltage. Moreover, compared to the battery U, the battery D exhibits a higher remaining capacity rate. The reason for this is probably the same as that described in the experiment of the first example. The experimental results described above show that the effects of the present invention can be achieved even when a lithium transition metal complex oxide other than lithium cobaltate is used.

### Fifth Example

### Example

A battery was produced as in Example 1 of the first example described above except that LiNi_{0.5}Co_{0.2}Mn_{0.30}O₂ (hereinafter may be referred to as Zr-dissolved NCM) in which 0.3 mol % of Zr was dissolved relative to the total amount of the transition metal was used as the lithium transition metal complex oxide and that a mixed solvent containing EC, MEC, and DEC at a volume ratio of 3:6:1 was used as the solvent of the nonaqueous electrolyte.

The battery produced thereby is hereinafter referred to as battery E.

### Comparative Example 1

A battery was produced as in Example of the fifth example except that a positive electrode active material not sprayed with a coating solution (positive electrode active material solely composed of Zr-dissolved NCM) was used.

The battery produced thereby is hereinafter referred to as battery V1.

### Comparative Example 2

A battery was produced as in Example of the fifth example except that ammonium fluoride was not added in preparing the coating solution.

The battery produced thereby is hereinafter referred to as battery V2.

### Experiment

The batteries E, V1, and V2 were subjected to charging/discharging, etc., under the same conditions as those of the experiment of the first example described above to examine the high-temperature continuous charge properties (proportion of battery swelling and remaining capacity rate). The results are shown in Table 6.

TABLE 6

| | Positive electrode | | | | |
|---|---|---|---|---|---|
| | active material | | | | |
| | Lithium | | | Proportion | Re- |
| | transition | Compound | | of battery | maining |
| | metal com- | attached to | Electro- | swelling | capacity |
| Battery | plex oxide | surface | lyte | (%) | rate (%) |
| Battery E | Zr-dissolved | Zr—F | EC/ | 25.9 | 82.1 |
| Battery V1 | NCM | None | MEC/ | 45.0 | 78.0 |
| Battery V2 | | Zr—O | DEC | 95.9 | 79.4 |

Table 6 shows that, in the case where Zr-dissolved NCM is used as the lithium transition metal complex oxide, the proportion of battery swelling is high in the battery V2 in which zirconium oxide is attached to the surfaces of Zr-dissolved NCM compared to the battery V1 in which no compound is attached to the surfaces of Zr-dissolved NCM. In contrast, the proportion of battery swelling is low in the battery E in which a compound containing zirconium and fluorine is attached to the surfaces of Zr-dissolved NCM compared to the battery V1. The experimental results described above show that an effect of specifically suppressing battery swelling is exhibited when Zr-dissolved NCM is used and a compound containing zirconium and fluorine is attached to the surfaces of Zr-dissolved NCM.

### Sixth Example

### Example

A battery was produced as in Example 1 of the first example described above except that a spinel nickel lithium manganate represented by LiNi_{0.5}Mn_{1.5}O₄ (hereinafter may be referred to as spinel NM) was used as the lithium transition metal complex oxide.

The battery produced thereby is hereinafter referred to as battery F.

### Comparative Example

A battery was produced as in Example of the sixth example except that a positive electrode active material not sprayed with a coating solution (positive electrode active material solely composed of spinel NM) was used.

The battery produced thereby is hereinafter referred to as battery W.

### Experiment

The batteries F and W were subjected to charging/discharging, etc., under the same conditions as those of the experiment of the first example except that the discharge current was changed to 0.2 It (150 mA), the end-of-charge voltage was changed to 4.8 V, and the end-of-discharge voltage was changed to 3.0 V to examine the high-temperature continuous charge properties (battery swelling amount and remaining capacity rate). The results are shown in Table 7. In Table 7, the battery swelling amount is indicated as an index number relative to the battery swelling amount of the battery W which is assumed to be 100 and the remaining capacity rate is indicated as an index number relative to the remaining capacity rate of the battery W which is assumed to be 100.

TABLE 7

| | Positive electrode | | | | |
|---|---|---|---|---|---|
| | active material | | | | |
| | Lithium | | | | |
| | transition | Compound | | Battery | Remaining |
| | metal com- | attached to | Electro- | swelling | capacity |
| Battery | plex oxide | surface | lyte | amount | rate |
| Battery F | Spinel NM | Zr—F | EC/DEC | 79.3 | 140.6 |
| Battery W | | None | | 100.0 | 100.0 |

Table 7 shows that battery swelling is significantly suppressed in the battery F in which a compound containing zirconium and fluorine is the compound attached to surfaces of spinel NM even after the battery is retained at high temperature and high voltage compared to the battery W in which no compound is attached to the surfaces of spinel NM. Moreover, the battery F exhibits a higher remaining capacity rate than the battery W. The reason for this is probably the same as that described in the experiment of the first example described above. The experimental results described above confirm that not only the effects of the present invention are exhibited even when a lithium transition metal complex oxide other than lithium cobaltate is used but also the same effects are exhibited at a significantly high potential of 4.9 V on a lithium metal basis.

### (Other Features)

(1) Examples of the compound containing zirconium and fluorine used in the present invention include zirconium difluoride (ZrF₂), zirconium trifluoride (ZrF₃), and zirconium tetrafluoride (ZrF₄). These compounds containing zirconium and fluorine may partly contain O and/or OH.
(2) The compound containing zirconium and fluorine is preferably attached to surfaces of the lithium transition metal complex oxide. When the compound is attached to the surfaces of the lithium transition metal complex oxide, the compound rarely detaches from the lithium transition metal complex oxide and the actions and effects of the present invention can be further enhanced.

The method for causing a compound containing zirconium and fluorine to attach to the surfaces of a lithium transition metal complex oxide may be spraying of a solution containing zirconium and fluorine onto a lithium transition metal complex oxide while stirring the lithium transition metal complex oxide. Since this method is simple, the increase in battery production cost can be suppressed.

(3) Examples of the lithium transition metal complex oxide used in the present invention include oxides of lithium and transition metals such as lithium cobaltate, nickel-cobalt-lithium manganate, nickel-cobalt-lithium aluminate, nickel-lithium cobaltate, nickel-lithium manganate, lithium nickelate, and lithium manganate, olivine acid compounds of iron, manganese, etc., and other known compounds.
(4) The content of the compound containing zirconium and fluorine that is present at the surfaces of the lithium transition metal complex oxide is preferably 0.0094 mass % or more and 0.47 mass % or less on a zirconium element basis relative to the lithium transition metal complex oxide. At a content less than 0.0094 mass %, the content of the compound containing zirconium and fluorine is excessively small and the action and effects brought by the addition of the compound may not sufficiently be exhibited. At a content exceeding 0.47 mass %, the surfaces of the lithium transition metal complex oxide may become excessively coated with a compound that does not readily and directly contribute to the charge and discharge reactions and the discharge performance may be degraded.
(5) In the lithium transition metal complex oxide, substances such as Al, Mg, Ti, and Zr may be dissolved or contained in grain boundaries. A compound of Al, Mg, Ti, Zr, or the like may be attached to the surfaces of the lithium transition metal complex oxide together with the compound containing zirconium and fluorine. This is because the contact between the electrolyte and the lithium transition metal complex oxide can still be suppressed even when these compounds are attached.
(6) The solvent of the nonaqueous electrolyte used in the present invention is not limited and any solvent that has been conventionally used in nonaqueous electrolyte secondary batteries can be used. Examples thereof include cyclic carbonates such as ethylene carbonate, propylene carbonate, butylene carbonate, and vinylene carbonate; chain carbonates such as dimethyl carbonate, methyl ethyl carbonate, and diethyl carbonate; ester-containing compounds such as methyl acetate, ethyl acetate, propyl acetate, methyl propionate, ethyl propionate, and γ-butyrolactone; sulfone-group-containing compounds such as propane sultone; ether-containing compounds such as 1,2-dimethoxyethane, 1,2-diethoxyethane, tetrahydrofuran, 1,2-dioxane, 1,4-dioxane, and 2-methyltetrahydrofuran; and amide-containing compounds such as dimethylformamide. In particular, a solvent in which some of H atoms in these compounds are substituted with F is preferably used. These compounds can be used alone or in combination. In particular, a solvent in which a cyclic carbonate and a chain carbonate are used in combination and a solvent in which a small amount of a nitrile-containing compound or an ether-containing compound is used in combination with the cyclic and chain carbonates are preferable.

Solutes that have been conventionally used can be used as the solute of the nonaqueous electrolyte. Examples thereof include lithium salts such as LiPF₆, LiBF₄, LiN(SO₂CF₃)₂, LiN(SO₂C₂F₅)₂, and LiPF₆, (CₙF₂ₙ₋₁)ₓ [ where 1<x<6, n=1 or 2] and lithium salts in which oxalate complexes serve as anions. Examples of the lithium salts in which oxalate complexes serve as anions include LiBOB [lithium-bisoxalate borate] and lithium salts having an anion in which C₂O₄²⁻ is coordinated to the center atom, e.g., Li[M(C₂O₄)ₓR_{y}] (where M represents an element selected from transition metals, and group IIIb, IVb, and Vb elements in the periodic table, R represents a group selected from a halogen, an alkyl group, and a halogen-substituted alkyl group, x represents a positive integer, and y represents 0 or a positive integer). Specific examples include Li[B (C₂O₄) F₂], Li[P(C₂O₄)F₄], and Li[P(C₂O₄)₂F₂]. However, use of LiBOB is most preferable in order to form stable coating films on surfaces of a negative electrode in a high temperature environment.

Note that the solutes described above may be used alone or in combination as a mixture. The concentration of the solute is not particularly limited but is preferably 0.8 to 1.7 mol per liter of the electrolyte.

(7) Negative electrodes that have been conventionally used can be used as the negative electrode of the present invention. Examples thereof include carbon materials that can occlude and release lithium, metals that can form alloys with lithium, and alloy compounds that contain such metals.

Graphite such as natural graphite, non-graphitizable carbon, and artificial graphite, and cokes can be used as the carbon material. Examples of the alloy compounds include compounds that contain at least one metal that can form an alloy with lithium. In particular, the element that can form an alloy with lithium is preferably silicon or tin. Silicon oxide, tin oxide, etc., obtained as a result of bonding of oxygen with these elements can also be used. Moreover, a mixture of a carbon material and a compound of silicon or tin can be used.

In addition to these described above, a material that has a higher potential of charge and discharge relative to metallic lithium such as lithium titanate than the carbon materials can be used as the negative electrode active material although the energy density is lowered in this case.

(8) A layer formed of an inorganic filler that has been conventionally used can be formed at the interface between the positive electrode and the separator or the interface between the negative electrode and the separator. Fillers that have been conventionally used, such as oxides and phosphoric acid compounds of one or more of aluminum, silicon, magnesium, etc., and those surface-treated with a hydroxide or the like, can be used as the filler.

The filler layer can be formed by a method with which a filler-containing slurry is directly applied to a positive electrode, a negative electrode, or a separator or a method with which a sheet formed of a filler is attached to a positive electrode, a negative electrode, or a separator.

(9) Conventionally used separators can be used as the separator used in the present invention. In particular, not only a polyethylene separator but also a separator in which a polypropylene layer is formed on a surface of a polyethylene layer and a separator in which a resin such as an aramid resin is applied to a surface of a polyethylene separator can be used.
(10) The nitrile added to the nonaqueous electrolyte is not limited to adiponitrile and may be a nitrile-containing compound such as butyronitrile, valeronitrile, n-heptane nitrile, succinonitrile, gultaronitrile, adiponitrile, pimelonitrile, 1,2,3-propanetricarbonitrile, and 1,3,5-pentanetricarbonitrile. In particular, when two or more nitrile groups are present and the number of carbon atoms including the carbon atoms in the nitrile groups is 4 or more, stable coating films can be formed and the reaction of decomposition of the electrolyte that leads to generation of gas can be suppressed. Accordingly, two or three nitrile groups are preferably present and the number of carbon atoms is preferably 4 or more. Adiponitrile, succinonitrile, glutaronitrile, pimelonitrile, 1,2,3-propanetricarbonitrile, 1,3,5-pentatricarbonitrile, and the like are preferable.

### INDUSTRIAL APPLICABILITY

The present invention can be expected to be developed into drive power sources of portable information terminals such as cellular phones, laptop personal computers, and smart phones, and high-output drive power sources of HEVs and power tools.

### REFERENCE SIGNS LIST

1: positive electrode
2: negative electrode
3: separator
4: positive electrode current collecting tab
5: negative electrode current collecting tab
6: aluminum laminate outer casing

1.-8. (canceled)

9. A positive electrode active material for a nonaqueous electrolyte secondary battery, comprising a lithium transition metal complex oxide and a compound containing zirconium and fluorine, wherein the compound is present at a surface of the lithium transition metal complex oxide.

10. The positive electrode active material for a nonaqueous electrolyte secondary battery according to claim 9, wherein the compound containing zirconium and fluorine is attached to the surface of the lithium transition metal complex oxide.

11. The positive electrode active material for a nonaqueous electrolyte secondary battery according to claim 9, wherein zirconium is dissolved in the lithium transition metal complex oxide.

12. The positive electrode active material for a nonaqueous electrolyte secondary battery according to claim 10, wherein zirconium is dissolved in the lithium transition metal complex oxide.

13. A positive electrode for a nonaqueous electrolyte secondary battery, comprising:
a positive electrode current collector; and
a positive electrode mix layer being formed on at least one surface of the positive electrode current collector and containing a binder and the positive electrode active material according to claim 9.

14. A positive electrode for a nonaqueous electrolyte secondary battery, comprising:
a positive electrode current collector; and
a positive electrode mix layer being formed on at least one surface of the positive electrode current collector and containing a binder and the positive electrode active material according to claim 10.

15. A positive electrode for a nonaqueous electrolyte secondary battery, comprising:
a positive electrode current collector; and
a positive electrode mix layer being formed on at least one surface of the positive electrode current collector and containing a binder and the positive electrode active material according to claim 11.

16. A nonaqueous electrolyte secondary battery comprising:
the positive electrode according to claim 13;
a negative electrode containing a negative electrode active material; and
a nonaqueous electrolyte.

17. A nonaqueous electrolyte secondary battery comprising:
the positive electrode according to claim 14;
a negative electrode containing a negative electrode active material; and
a nonaqueous electrolyte.

18. A nonaqueous electrolyte secondary battery comprising:
the positive electrode according to claim 15;
a negative electrode containing a negative electrode active material; and
a nonaqueous electrolyte.

19. The nonaqueous electrolyte secondary battery according to claim 16, wherein a compound containing a nitrile group is added to the nonaqueous electrolyte.

20. The nonaqueous electrolyte secondary battery according to claim 17, wherein a compound containing a nitrile group is added to the nonaqueous electrolyte.

21. The nonaqueous electrolyte secondary battery according to claim 18, wherein a compound containing a nitrile group is added to the nonaqueous electrolyte.

22. The nonaqueous electrolyte secondary battery according to claim 19, wherein a compound having 4 or more carbon atoms and 2 or 3 nitrile groups is added to the nonaqueous electrolyte.

23. The nonaqueous electrolyte secondary battery according to claim 20, wherein a compound having 4 or more carbon atoms and 2 or 3 nitrile groups is added to the nonaqueous electrolyte.

24. The nonaqueous electrolyte secondary battery according to claim 21, wherein a compound having 4 or more carbon atoms and 2 or 3 nitrile groups is added to the nonaqueous electrolyte.

25. A method for producing a positive electrode active material for a nonaqueous electrolyte secondary battery, comprising spraying a solution containing zirconium and fluorine onto a lithium transition metal complex oxide while the lithium transition metal complex oxide is being stirred so as to attach a compound containing zirconium and fluorine onto a surface of the lithium transition metal complex oxide.
